(19) United States
(12) Patent Application Publication
(10) Pub. No.: US 2004/0025295 A1
(43) Pub. Date: Feb. 12, 2004

(54) Clearance free hinge for an automotive vehicle seat

(75) Inventors: Burckhard Becker, Solingen (DE); Wilfried Beneker, Leichlingen (DE)

Correspondence Address: AKERMAN SENTERFITT, P.O. BOX 3188, WEST PALM BEACH, FL, 33402-3188, US

(73) Assignee: C. Rob. Hammerstein GmbH & Co. KG, Solingen (DE)

(21) Appl. No.: 10/602,288

(22) Filed: Jun. 24, 2003

(30) Foreign Application Priority Data
Jul. 5, 2002 (DE) 102 30 589.7

(51) Int. Cl. E05D 7/10

(52) U.S. Cl. 16/254

(57) ABSTRACT

A clearance free hinge for an automotive vehicle seat has a) a first hinge arm and a second hinge arm, each hinge arm having a bore, b) a hinge pin extending through said bores, the bore of the first hinge arm comprising a retaining zone and a compensation zone located one behind the other, the compensation zone having greater radial inner dimensions than the retaining zone and the compensation zone being defined by an inner lining and a step, which is oriented substantially radially and is contiguous to the retaining zone, and c) a shim member that rests against the inner lining, the step and the hinge pin and that, during assembly of the hinge, is loaded axially toward the step in such a manner that it deforms and fills out any space between hinge pin, step and inner lining.

### BACKGROUND OF THE INVENTION

The invention relates to a clearance free hinge for an automotive vehicle seat, for a seat adjusting device for example, meaning more specifically a hinge connection between a back rest and a seat carrier or hinge connections on parallelogram arms that are located between a seat carrier and a for and aft adjusting device.

A clearance free hinge connection, i.e. a hinge without play, intended for use in adjusting devices in automotive vehicles is known from DE 197 31 305 C2. It has two joint arms provided with one bore each. A hinge pin extends through the two bores. There is necessarily a bearing gap between the bore and the hinge pin. A shim member is provided, said shim member being substantially disc-shaped but having an axial projection capable of penetrating into the bearing gap.

With automotive vehicle seats, an important goal is to provide hinge connections without any clearance. Due to the quite great length of a back rest, even a small bearing clearance in the hinge joint of the back rest is clearly noticeable in the hinge connection between the back rest and the seat carrier, it can be perceived at the upper edge of a back rest.

On the one side, hinge connections in automotive vehicle seats are not adjusted very often, on the other side, adjustment is markedly slow, in most cases at distinctly less than one revolution per minute. Besides, most of the hinge connections are only pivot connections, full rotation of 360 degrees is not needed, the range of motion not exceeding 180 degrees in most cases.

The clearance free joint according to DE 197 31 305 C2 does not always ensure controlled penetration of the projection into the bearing gap. During assembly, it has to be made certain that the assembly gap is entirely surrounded, meaning that the hinge pin does not abut at one site against the inner wall of the associated bore. Only a relatively small axial portion of the overall axial length of the bore is used, the major portion of the axial length of the bore remaining without clearance compensation.

This is where the invention sets in. It has the object to indicate a clearance free viz. play free hinge in which secure clearance compensation is achieved over a predeterminable axial length.

### SUMMARY OF THE INVENTION

Starting from the prior art joint, the object of the invention is accomplished in that the bore of the first hinge arm comprises a retaining zone and a compensation zone disposed axially one behind the other, the compensation zone has greater radial inner dimensions than the retaining zone and the compensation zone is defined by a step oriented substantially radially and contiguous to the retaining zone and by an inner lining, and that a shim member is provided, said shim member abutting on the inner lining, on the step and on the hinge pin and being loaded axially toward the step during assembly of the joint in such a manner that it deforms and fills any space between hinge pin, step and lining.

In this clearance free joint, at least one hinge arm is made clearance free although it is also possible to configure the two hinge arms to be clearance free relative to the hinge pin. The bore is prepared to receive the shim member. For this purpose it is divided into two different zone portions disposed axially one behind the other. It has a retaining zone that quite closely surrounds the hinge pin with a clearance within manufacturing tolerances. A compensation zone is contiguous to said retaining zone, said compensation zone preferably having a length greater than that of the retaining zone. The compensation zone is prepared to receive an axially mountable shim member. The compensation zone within the bore is defined by the step, which is oriented substantially radially and is contiguous to the retaining zone, and by the inner lining. The latter is preferably conical.

Irrespective of special assembly conditions, it is always achieved that the shim member be capable of being axially inserted into the compensation zone during assembly. It comes to rest against the step which forms a radial step. This abutment is measurable. After insertion of the shim member there is a gap left between the shim member and the inner lining or hinge pin. This gap is needed for assembly. Through axial compression, which is achieved by screwing, or more specifically by riveting, the shim member is now deformed from the initial shape in such a manner that the space between hinge pin, step and lining is filled out, meaning that there is no clearance left.

The retaining or supporting zone thereby more specifically serves for accurate positioning, the compensation zone serves for compensating for the clearance and for selectively receiving the shim member.

Thanks to the step, the abutment is clearly perceived when, during assembly, the shim member is axially inserted into the compensation zone. A defined condition is concurrently obtained for the axial compression of the shim member which is to occur later on. While being subjected to axial load and tension, the shim member is supported by the step. A selective radial deformation is thus made possible. Altogether, defined conditions for the deformation of the shim member are obtained. Accordingly, the invention is specifically suited for series production as it is not necessary to make every single hinge connection to be specially adjustable like in the previously disclosed patent document which only teaches to provide axial tension by screwing.

In a preferred development, the inner lining rests on a cone with an aperture angle of between 0 and 45 degree. Accordingly, the force conditions achieved while the shim member is being introduced, meaning while the hinge is made clearance free, are advantageous.

The compensation zone is accessible from one of the surfaces of the first hinge arm, more specifically from the surface which is turned away from the region in which the two hinge arms touch each other. The compensation zone is implemented in such a manner that the shim member can be introduced by axially pushing it in.

As the hinge connection is made clearance free, the shim member is deformed. Before the hinge is being assembled the shim member preferably has an axial length which is greater than the spacing between the step and an area of the first hinge arm from which the compensation zone is accessible. The axial length of the shim member gets shorter as the hinge is made clearance free whereas the shim member extends in the radial direction.

Like in the prior patent it is preferable to provide the hinge pin with a radial step. But now, said step is intended to rest either on an inner surface of the first hinge arm or on an inner surface of the second hinge arm located directly opposite. While the hinge is made clearance free, the step effects a defined stop. In other words, the axial compression is performed in such a manner that the radial step is caused to abut; when this is achieved, the axial compression can be brought to an end.

Plastic materials are more specifically suited for realizing the shim member. The plastic materials used are preferably of the type which can mechanically deform when subjected to pressure, flowing thereby, meaning that they will not loose their unity, not even in part, that is to say that they will not tear or the like. It has been found that low density polyethylene for example, i.e., LDPE, is suited.

The material of the shim member is intended to exhibit good gliding properties. It is intended to absorb little water, to be temperature resistant and to exhibit good long-time stability.

In a particularly preferred embodiment, the compensation zone has an axial length that is not less than 50% of the thickness of the first hinge arm. The axial length of the compensation zone is preferably greater than that of the retaining zone. As a result the axial space available is sufficient for compensating for the clearance. This is considered to be a particular improvement on the approach of making hinge connections clearance free in large-scale production.

### BRIEF DESCRIPTION OF THE DRAWINGS

Further advantages and features of the invention will become more apparent upon reading the appended claims and the following non restrictive description of the preferred embodiments thereof, given by way of example only with reference to the drawing in which:

FIG. 1 is an assembly drawing in the form of an axial section through a hinge connection for illustrating the various component parts prior to assembly,

FIG. 2 is an axial sectional view of an embodiment similar to FIG. 1, but now in the assembled condition,

FIG. 3 is a perspective view of a shim member,

FIG. 4 is a perspective view of another shim member and

FIG. 5 is a perspective view of a third shim member.

### DETAILED DESCRIPTION OF THE INVENTION

A first hinge arm 20 and a second hinge arm 22 have one bore each, respectively 24 and 26. A hinge pin 28 is implemented in such a manner that it is adapted to extend through the two bores 24, 26 and that it forms a pivot axis after riveting, meaning after having formed a rivet head on the free end thereof.

The two hinge arms 20, 22 are only shown schematically herein. They may be any shape, for example that of a bearing pillow, an oscillating crank, a back rest carrier, a seat carrier or the like. Typically, the hinge arms 20, 22 are made from sheet iron, said sheet iron having a thickness of about 2 mm for example. In principle, the thickness of the sheet iron is not important for the invention.

A threaded bolt or any other type of bolt which is suited for forming the axis of a hinge connection can be utilized instead of a hinge pin 28.

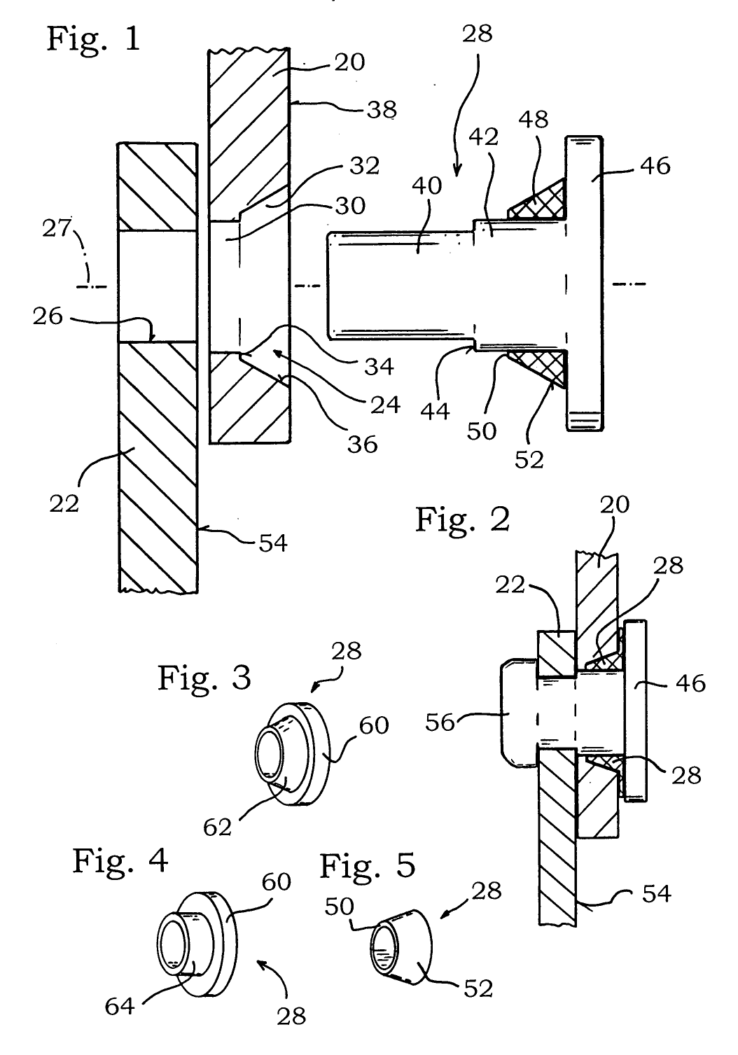

As shown in FIG. 1, the bore 24 of the first hinge arm is stepped. It is composed of a retaining zone 30 and of a compensation zone 32. In the retaining zone 30, the bore 24 has a diameter adapted to the outer diameter of the pin 28 so that the substantial step of positioning the hinge pin 28 within the bore 24 in the retaining zone 30 can be performed.

On the one hand, the compensation zone 32 has greater radial inner dimensions than the retaining zone 30 and on the other hand it also has a greater axial length than the retaining zone 30. It is defined by a step 34 that is immediately contiguous to the retaining zone 30 from which it extends as a flare portion and by an inner lining 36. The inner lining 36 is fastened to the outer edge of step 34 and extends toward the outermost surface 38 which is turned away from the region in which the two hinge arms 20, 22 are joining together, said lining being accessible from said outermost surface. In the exemplary embodiment shown, the inner lining 36 rests on the lining of a cone the aperture angle of which is approximately 60.degree. The hinge axis is indicated at 37.

The bore 26 of the second hinge arm 22 is a normal, cylindrical bore just like the retaining zone 30. As compared to the retaining zone 30 however, the inner diameter is smaller, e.g., from 5 to 30% smaller.

The hinge pin 28 has two cylindrical portions, namely a front cylindrical portion 40, which is adapted to the bore 26 of the second hinge arm 22, and a rear cylindrical portion 42, which is implemented for providing the most precise fit possible within the retaining zone 30. The two cylindrical portions 40, 42 are separated by a radial shoulder 44. Finally, the hinge pin 28 has a head 46 which is configured as a flat cylindrical body.

In FIG. 1, a shim member 48 has already been placed onto the rear cylindrical portion 42. It is ring-shaped and is implemented in such a manner that it can be introduced into the space defined by the step 34, the inner lining 36 and the rear cylindrical portion 42. The axial length of the shim member 48 is greater than that of the compensation zone 32. If inserted into the compensation zone 32, it protrudes e.g., some mm, in the region of the outermost surface 38. The shim member 48 has a step surface 50 adapted to step 34 and a lining surface 52 configured to conform to the inner lining 36 with respect to the angular orientation and so on of said lining. Altogether, the shim member 48 is formed so that it can be inserted directly in the axial direction into the compensation zone 32 without particular provisions. In the merely inserted condition, it almost, but not completely, fills out the compensation zone 32 so that joint gaps occur.

Herein after there will be provided a description of how to assemble the arrangement of FIG. 1 and how to make it clearance free in order to obtain a hinge connection as shown in FIG. 2: if the hinge pin 28 is inserted through the bores 24, 26, the rear cylindrical portion 42 is threaded into the retaining zone 30 before the shim member 48 is forced to come into contact with the inner walls of the retaining zone 30. Definite positioning is thus made possible. The front cylindrical portion 40 extends through the bore 26 and protrudes therefrom towards the left. In this condition, the head 46 is still spaced from the outermost surface 38, the radial shoulder 44 is also spaced from an inner surface 54 of the second hinge arm. As already explained, a rear portion of the shim member 48 protrudes from the compensation zone 32.

Now, riveting is performed, this process being monitored as accurately as possible, for example by monitoring the deformation; the reader is referred to DE 101 64 005.6. Instead of riveting the hinge pin 28, it may also be screwed or accordingly subjected to axial tension or load respectively.

The axial force causes the shim member 48 to be pressed into the compensation zone 32. The step surface 50 comes into close contact with step 34, the shim member 48 expands radially outward and fills the compensation zone 32 out so that in parts at least there is no gap or clearance left between the shim member 48 and the inner lining 36 or between the shim member 48 and the rear cylindrical portion 42 respectively.

After axial compression, the head 46 is in closer proximity to the outermost surface 38. A portion of the shim member 48 has penetrated the gap between head 46 and outermost surface 38. More specifically, the axial force is calculated to bring the radial shoulder 44 to rest against the inner surface 54.

It is also possible to insert the hinge pin 28 in the opposite direction; in this case, the bore 26 of the second hinge arm 22 must be greater than the bore 24 of the first hinge arm 20. Then, the radial shoulder 44 rests against an inner surface of the first hinge arm 20.

FIG. 2 shows a completed hinge that is not identical with the hinge of FIG. 1 but has a similar structure. The free end of the hinge pin 28 now flares to form a rivet head 56. Axially, the second hinge arm 22 is trapped with no clearance between the radial shoulder 44 and the rivet head 56. The first hinge arm 20 is also retained with no clearance between the inner surface of the second hinge arm 22 and that part of the shim member that is located in the gap between the head 46 and the outermost surface 38. The second hinge arm 22 is clearance free in the radial direction as well though. This is due to the portion of the shim member 48 that flares within the compensation zone 32. Said portion rests with as much of its surface as possible both against the inner lining 36 and the step 34.

Besides a suited plastic material, the material chosen for making the shim member 48 can also be a metal that is softer than the metal of the hinge arms 20, 22 or of the hinge pin 28 respectively.

The bore 24 is made in the following manner: At first, a hole having the diameter of what will later be the retaining zone 30, possibly a slightly larger diameter, is made by drilling, punching and so on. Then, the compensation zone is stamped, material being displaced to and into the site of the retaining zone using a stamping tool. Eventually, the retaining zone 30 is punched, drilled or completed in another similar way and is given the right inside diameter of the retaining zone 30.

In the FIGS. 3 to 5, various embodiments of the shim member 48 are shown. They are all turned parts. In the embodiment of FIG. 3, the shim member consists of a disc 60 and of a cone ring 62 placed thereon, both having the same inside diameter which also conforms to the outside diameter of the rear cylindrical portion 42.

In the embodiment of FIG. 4, a disc 60 is also provided, but now the actual shim member is a cylindrical ring 64. The axial length of this cylindrical ring 64 and the axial length of the truncated cone 62 are greater than the axial length of the retaining zone 30.

Finally, FIG. 5 shows a shim member 48 that substantially corresponds to the cone ring of the embodiment of FIG. 3.

1. A clearance free hinge for an automotive vehicle seat comprising in combination:
a first hinge arm and a second hinge arm, each hinge arm having a bore, the bore of the first hinge arm comprising a retaining zone and a compensation zone located one behind the other, the compensation zone having greater radial inner dimensions than the retaining zone and the compensation zone being defined by an inner lining and a step, which step is oriented substantially in a radial direction and is contiguous to the retaining zone;
a hinge pin extending through said bores; and
a shim member that rests against the inner lining, the step and the hinge pin which shim member, during assembly of the hinge, is pushed axially toward the step whereby the shim member deforms and fills out any space between hinge pin, step and inner lining.

2. The clearance free hinge of claim 1, wherein the inner lining is defined by a cone having an aperture angle between 0 and 90 degrees.

3. The clearance free hinge of claim 1, wherein, before assembly of the hinge, the shim member has an axial length which axial length is greater than the distance between the step and an outer surface of the first hinge arm which outer surface defines an end of the compensation zone.

4. The clearance free hinge of claim 1, wherein the hinge pin has a radial shoulder resting either on an inner surface of the first hinge arm or on an inner surface of the second hinge arm located directly opposite the inner surface of the first hinge arm.

5. The clearance free hinge of claim 1, wherein the shim member is made from a mechanically deformable plastic material.

6. The clearance free hinge of claim 1, wherein the retaining zone is dimensioned so as to be capable of taking a maximum radial tensile load which acts between the first hinge arm and the hinge pin and for which the hinge is designed.

7. The clearance free hinge of claim 1, wherein the compensation zone has an axial length that is not smaller than 50% of the axial length of the bore of the first hinge arm.

8. The clearance free hinge of claim 1, wherein the shim member has a front portion, and wherein prior to assembling the hinge, the shim member has an initial shape, the front portion of the shim member being insertable into the retaining zone and after assembly the shim member having a final shape in which it is plastically deformed relative to the initial shape.

9. The clearance free hinge of claim 1, wherein the inner lining is defined by a cone having an aperture angle between 10 and 45 degrees.

10. The clearance free hinge of claim 1, wherein before, and also after assembly of the hinge, the shim member has a greater axial length than the distance between the step and an outer surface of the first hinge arm which outer surface defines an end of the compensation zone.

11. The clearance free hinge of claim 1, wherein the shim member is made from LDPE.
